(19) United States
(12) Patent Application Publication
(10) Pub. No.: US 2021/0048336 A1
(43) Pub. Date: Feb. 18, 2021

(54) ABNORMAL-SOUND DETERMINATION CRITERION GENERATION DEVICE, ABNORMAL-SOUND CRITERION GENERATION METHOD, ABNORMAL-SOUND SENSING DEVICE, AND STORAGE MEDIUM

(71) Applicant: NEC CORPORATION, Tokyo (JP)

(72) Inventor: Mitsuru SENDODA, Tokyo (JP)

(73) Assignee: NEC CORPORATION, Tokyo (JP)

(21) Appl. No.: 16/964,448

(22) PCT Filed: Feb. 15, 2019
(86) PCT No.: PCT/JP2019/005463

§ 371 Date: Jul. 23, 2020

(30) Foreign Application Priority Data
Feb. 16, 2018 (JP) 2018-026169

(51) Int. Cl. G01H 9/00; G06N 20/00

(52) U.S. Cl. CPC G01H 9/00; G06N 20/00

(57) ABSTRACT

A device for generating an abnormal-sound determination reference has an imaging means, an action pattern discrimination means, a sound collecting means, an action sound discrimination means, and a reference action sound learning means. The action discrimination means discriminates and stores an action pattern of a diagnosis object on the basis of an image of the diagnosis object captured by the imaging means. The action sound discrimination means discriminates the action pattern discriminated by the action pattern discrimination means and a pattern of a sound collected in synchronization with the action pattern, and stores the pattern of sound as an action sound corresponding to the action pattern. The reference action sound learning means machine-learns an action sound corresponding to each action pattern for the stored action sound, and generates and stores a reference action sound corresponding to the action pattern.

### TECHNICAL FIELD

The present invention relates to an abnormal-sound determination criterion formation device and an abnormal-sound sensing device.

### BACKGROUND ART

As a technique for diagnosing equipment or the like operating in a factory, a plant, or the like, there is known a method that senses an abnormal characteristic, based on a sound generated by the equipment. In recent years, in various devices, particularly, production facilities running in a factory or a power plant, a delay resulting from a failure influences productivity and cost, and therefore, is not permitted. A great cost may be needed for recovery, and predicting or quickly solving a failure is required.

Accordingly, as a technique for diagnosing equipment or the like operating in a factory, a power plant, or the like, there is known a method that diagnoses an abnormal characteristic, based on a sound generated by the equipment.

For example, PTL 1 discloses a technique of analyzing a collected sound, and estimating a cause when an abnormal sound is generated. This technique previously registers an abnormal sound for each cause to be a criterion, and performs sensing of an abnormality and estimation of a cause by comparing a collected sound with the abnormal sound for each cause to be a criterion. Specifically, the technique represents a sound by a multi-dimensional vector in which time and a frequency are dimensions, calculates a distance in a criterion space for each cause between a vector of the collected sound and a vector of the previously registered abnormal sound, and estimates that an abnormality resulting from the cause occurs when the distance is short.

PTL 2 discloses an abnormality monitoring device that senses an abnormality by use of both a sound and an image. The abnormality monitoring device is equipped with an abnormal-sound database in which spectral analysis results of voice information of abnormalities in a plurality of monitoring targets are registered. The abnormality monitoring device senses an abnormal sound by comparing a spectral analysis result of a collected sound with the registered spectral analysis result of the abnormal sound to be a criterion. For an image, the abnormality monitoring device performs edge detection of a monitoring target by binarizing the image. The abnormality monitoring device senses an abnormality by comparing variation in an area of the monitoring target or movement of an edge with a threshold value. Further, the abnormality monitoring device also attempts to estimate a kind of abnormality from a combination of a feature of image variation and a feature of the abnormal sound.

### CITATION LIST

### Patent Literature

[PTL 1] Japanese Unexamined Patent Application Publication No. 2004-205215
[PTL 2] Japanese Unexamined Patent Application Publication No. H09-097392

### SUMMARY OF INVENTION

### Technical Problem

However, the technique described in PTL 1 detects an abnormality with an analysis result of a known abnormal sound as a criterion, and therefore, has a problem that great amounts of time and labor have to be spent on initial setting. This is because a huge amount of evaluation items to be criterions, and a threshold value for each evaluation item need to be set before a diagnosis.

The technique described in PTL 2 also has a problem that an unknown abnormal sound fails to be detected. This is because a spectral analysis result of a known abnormal sound is used as a determination criterion of an abnormal sound. The technique described in PTL 2 is able to deal with an unknown abnormality as well in determination of an abnormality from an image, but needs to set a threshold value to be a criterion for determining an abnormality, for variation of a monitoring target image. Generally, this threshold value differs depending on a monitoring target, needs to be set individually according to a monitoring target, and requires time and labor for setting. There is also a problem that incorrect sensing increases when setting of a threshold value is inappropriate. Since there is no procedure of objectively determining a threshold value to be a criterion, and a threshold value is determined with aid of human experience and instinct, there is also a problem that detection precision of an abnormality depends on a person.

The present invention has been devised in order to solve the problems described above, and an object thereof is to provide an abnormal-sound determination criterion generation device that is capable of detecting an unknown abnormal sound, and generates an abnormal-sound determination criterion having high detection precision.

### Solution to Problem

In order to solve the problems described above, an abnormal-sound determination criterion generation device according to the present invention includes an imaging means, an operation pattern discrimination means, a sound collection means, an operation sound pattern discrimination means, and a criterion operation sound learning means. The operation discrimination means discriminates and stores an operation pattern of a diagnosis object, based on a video of the diagnosis object being captured by the imaging means. The operation sound discrimination means discriminates an operation pattern discriminated by the operation pattern discrimination means and a pattern of a sound collected in synchronization with the operation pattern, and stores the sound as an operation sound relevant to the operation pattern. The criterion operation sound learning means machine-learns an operation sound relevant to each operation pattern for the stored operation sound, and generates and stores a criterion operation sound relevant to the operation pattern.

### Advantageous Effects of Invention

An advantageous effect of the present invention is that an abnormal-sound determination criterion generation device that is capable of detecting an unknown abnormal sound, and generates an abnormal-sound determination criterion having high detection precision can be provided.

### BRIEF DESCRIPTION OF DRAWINGS

FIG. 1 is a block diagram illustrating an abnormal-sound determination criterion generation device according to a first example embodiment.

FIG. 2 is a block diagram illustrating an abnormal-sound determination criterion generation device according to a second example embodiment.

FIG. 3 is a schematic diagram for describing machine-learning of a criterion operation sound according to the second example embodiment.

FIG. 4 is a schematic diagram illustrating relevance of an operation pattern and an operation sound pattern in machine-learning according to the second example embodiment.

FIG. 5 is a flowchart illustrating a machine-learning operation of a criterion operation sound according to the second example embodiment.

FIG. 6 is a block diagram illustrating an abnormal-sound sensing device according to a third example embodiment.

FIG. 7 is a block diagram illustrating a configuration example of the abnormal-sound sensing device according to the third example embodiment.

FIG. 8 is a flowchart illustrating an abnormal-sound sensing operation according to the third example embodiment.

FIG. 9 is a block diagram illustrating an abnormal-sound determination criterion generation device according to a fourth example embodiment.

FIG. 10 is a schematic diagram for describing an abnormal-sound determination operation according to the fourth example embodiment.

FIG. 11 is a schematic diagram illustrating relevance of an operation pattern and an operation sound pattern in abnormal-sound determination according to the fourth example embodiment.

FIG. 12 is a block diagram illustrating an abnormal-sound sensing device according to a fifth example embodiment.

FIG. 13 is a schematic diagram for describing an abnormal-sound sensing operation according to the fifth example embodiment.

FIG. 14 is a schematic diagram illustrating relevance of an operation pattern and an operation sound pattern in abnormal-sound determination according to the fifth example embodiment.

FIG. 15 is a flowchart illustrating an abnormal-sound sensing operation according to the fifth example embodiment.

### EXAMPLE EMBODIMENT

Example embodiments of the present invention will be described below in detail with reference to the drawings. A technically preferable limitation is imposed on the example embodiments described below in order to implement the present invention, but does not limit the scope of the invention to the following. The same reference sign may be assigned to a similar component in each drawing, and description thereof may be omitted.

### First Example Embodiment

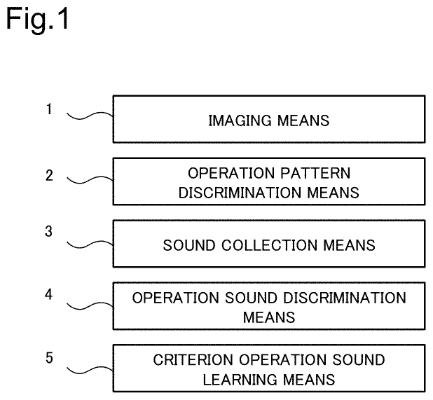

FIG. 1 is a block diagram illustrating an abnormal-sound determination criterion generation device according to the present example embodiment. The abnormal-sound determination criterion generation device includes an imaging means 1, an operation pattern discrimination means 2, a sound collection means 3, an operation sound discrimination means 4, and a criterion operation sound learning means 5.

The imaging means 1 captures a video of a diagnosis object.

The operation pattern discrimination means 2 discriminates and stores an operation pattern of the diagnosis object, based on the video captured by the imaging means 1.

The sound collection means 3 collects a sound arriving from the diagnosis object.

The operation sound discrimination means 4 discriminates an operation pattern discriminated by the operation pattern discrimination means 2 and a pattern of a sound collected in synchronization with the operation pattern, and stores the sound as an operation sound relevant to the operation pattern.

The criterion operation sound learning means 5 machine-learns an operation sound relevant to each operation pattern for the stored operation sound, and generates and stores a criterion operation sound relevant to the operation pattern. This criterion operation sound becomes a criterion for determining whether an operation sound when the operation pattern is observed is a normal sound or an abnormal sound.

With the above configuration, a determination criterion of an operation sound relevant to an operation pattern of a diagnosis object can be generated even when a feature of an abnormal sound is unknown.

### Second Example Embodiment

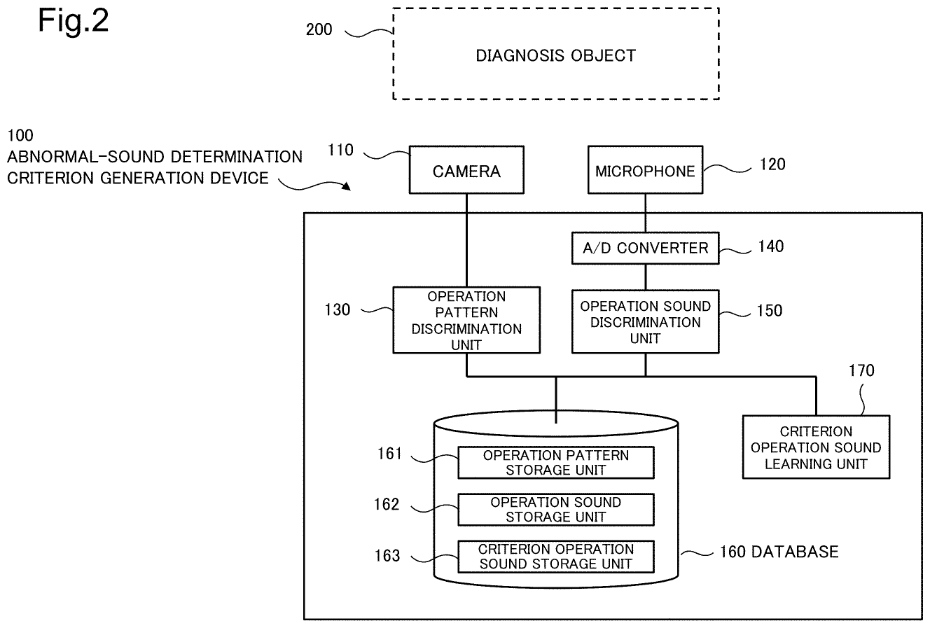

FIG. 2 is a block diagram illustrating an abnormal-sound determination criterion generation device 100 according to the present example embodiment. The abnormal-sound determination criterion generation device 100 includes a camera 110 that captures a diagnosis object 200, and a microphone 120 that collects a sound arriving from the diagnosis object. The abnormal-sound determination criterion generation device 100 also includes an operation pattern discrimination unit 130, an A/D converter 140, an operation sound discrimination unit 150, a database 160, and a criterion operation sound learning unit 170. Herein, A/D is an abbreviation of analog/digital. The database 160 includes an operation pattern storage unit 161 that stores an discriminated operation pattern, an operation sound storage unit 162 that stores an operation sound relevant to the operation pattern, and a criterion operation sound storage unit 163 that stores a criterion operation sound.

The operation pattern discrimination unit 130 discriminates an operation pattern from a video captured by the camera 110. Although a discrimination method of an operation pattern may be any method, discrimination can be performed by use of a feature vector representing motion of a feature point extracted from a video, for example. A component of a feature vector can be, for example, a movement amount of each feature point in x, y, and z directions in a predetermined period. Since a feature vector is equivalent to a differential of an operation, the operation can be represented by adding the feature vectors in a time-series way. When a time-series arrangement of the feature vectors has a law, the arrangement can be discriminated as an operation pattern. The operation pattern discrimination unit 130 stores the discriminated operation pattern in the operation pattern storage unit 161. The database may be abbreviated as DB in the following description.

The A/D converter 140 converts a sound collected with the microphone 120 into a digital signal. The operation sound discrimination unit 150 receives the digital signal, and discriminates a pattern of a sound synchronizing with the operation pattern discriminated by the operation pattern discrimination unit 130. The operation sound discrimination unit 150 stores the pattern of the sound in the operation sound storage unit 162 as an operation sound associated with the operation pattern. Although a discrimination method of an operation sound (sound pattern) may be any method, discrimination can be performed by representing the operation sound as a feature vector of a sound synchronizing with an operation pattern, for example. In this case, for example, time sections acquired by dividing a period synchronizing with an operation pattern into predetermined steps can be set, and a feature vector having, as a component, intensity of a sound at each time can be generated. It is also possible to use a feature vector having, as a component, sound pressure for each frequency serving as a sample, by performing frequency resolution (Fourier transform) in a period synchronizing with an operation pattern. When there is regularity in a relation between a feature vector of an operation sound generated in this way, and an operation pattern, the operation sound can serve as a criterion operation sound relevant to the operation pattern.

The criterion operation sound learning unit 170 machine-learns a criterion operation sound relevant to an operation pattern. Specifically, for example, first, measurement of an operation sound collected in synchronization with an operation pattern discriminated from a video is performed for a predetermined period or a predetermined number of times. Next, the criterion operation sound learning unit 170 machine-learns a criterion operation sound relevant to the operation pattern, by statistically processing data on the collected operation sound. A criterion value, an allowable limit value, or the like of an operation sound can be set as a criterion operation sound. Although a method of machine learning may be any method, a self-organizing map method, a k-nearest neighbor method, or the like can be used, for example. The criterion operation sound learning unit 170 stores the learned criterion operation sound in the criterion operation sound storage unit 163.

Hardware of the abnormal-sound determination criterion generation device 100 can be constituted of, for example, the camera 110, the microphone 120, the A/D converter 140, a computer, and a storage device. In this instance, for example, the operation pattern discrimination unit 130, the operation sound discrimination unit 150, and the criterion operation sound learning unit 170 can be implemented on the computer, and the database 160 can be implemented on the storage device.

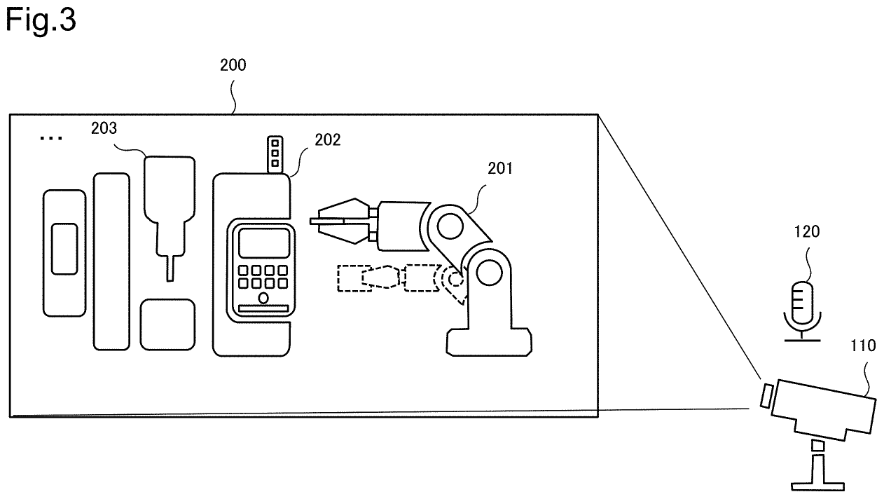

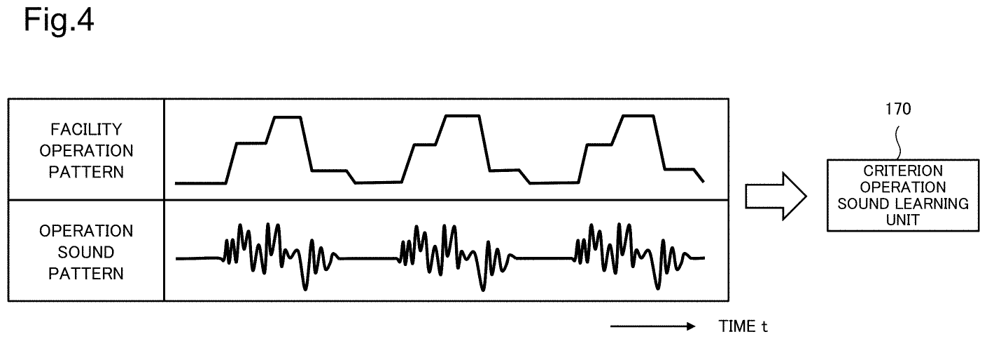

FIG. 3 is a schematic diagram for describing machine-learning of a criterion operation sound. As illustrated in FIG. 3, the camera 110 captures a video of the diagnosis object 200, and the microphone 120 collects a sound arriving from the diagnosis object. Herein, a scene in which a diagnosis object is a facility running in a factory is assumed as an example. It is assumed that elements in the video include facilities 201, 202, 203, . . . . In FIG. 4, a graph schematically illustrating an operation pattern of each of the facilities, and a graph representing an operation sound pattern synchronizing with the operation pattern are depicted. A situation in which the criterion operation sound learning means 170 machine-learns a combination of an operation pattern and an operation sound is schematically depicted. Herein, an example in which the same operation is periodically repeated as in many facilities is illustrated.

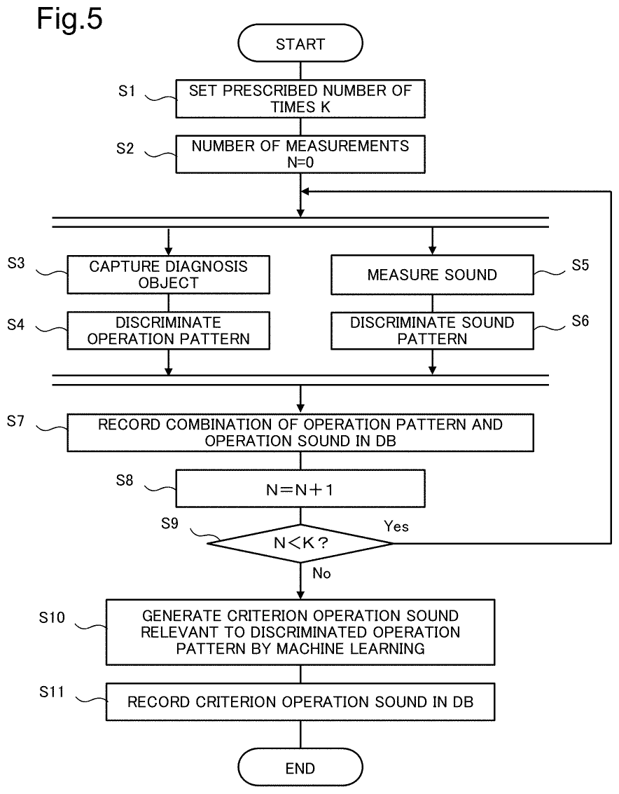

FIG. 5 is a flowchart representing a learning operation of a criterion operation sound. First, a measurement period or the number of measurements for performing learning is set (S1). For example, when a running state of a facility of a factory or the like is continuously monitored, setting may be performed with the number of times of a predetermined operation because a facility or the like repeatedly performs the same operation. Thus, herein, description is given assuming that setting is performed with the number of times. Setting may be performed with a predetermined period. At start of machine learning, a number of measurements N is reset. In other words, N=0 is set (S2).

Next, capture of a diagnosis object by the camera 110 is started in order to collect data for learning (S3). Then, an operation pattern of the diagnosis object is discriminated from the captured video (S4). In parallel with the capture of the video, sound collection by the microphone 120 is started (S5). Further, a pattern of the collected sound is discriminated (S6). Next, a pattern of a sound synchronizing with the discriminated operation pattern is recorded in a database (DB) as data on an operation sound in the operation pattern (S7). After recording, N=N+1 is set by adding 1 to the number of measurements N (S8). Herein, when the updated N is less than a predetermined number of times K (S9_Yes), a return is made to S3 and S5, and measurement of a video and a sound is repeated. On the other hand, when N=K (S9_No), machine learning for statistically processing data on an operation sound relevant to each discriminated operation pattern is performed, and a criterion operation sound relevant to each operation pattern is generated (S10). Each criterion operation sound is recorded in the DB (S11).

As described above, according to the present example embodiment, a criterion operation sound to be a determination criterion of an abnormal sound can be generated without previously setting a feature of an abnormal sound. Thus, for an unknown abnormal sound as well, an abnormal-sound determination criterion enabling detection of the unknown abnormal sound can be generated.

### Third Example Embodiment

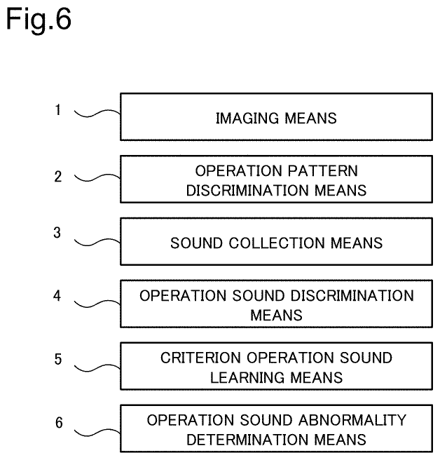

FIG. 6 is a block diagram illustrating an abnormal-sound sensing device according to the present example embodiment. The abnormal-sound sensing device is constituted of the abnormal-sound determination criterion generation device according to the first example embodiment, and an operation sound abnormality determination means 6.

The operation sound abnormality determination means 6 refers to a criterion operation sound relevant to the operation pattern when an operation pattern discriminated by an operation pattern discrimination means 2 is a stored operation pattern. The operation sound abnormality determination means 6 compares the criterion operation sound with a current operation sound discriminated by an operation sound discrimination means 4. Herein, when a difference between the current operation sound and the criterion operation sound is equal to or more than a predetermined value, the operation sound abnormality determination means 6 determines that the operation sound is an abnormal sound. A difference between the current operation sound and the criterion operation sound can be calculated as a distance in a vector space of a feature vector, for example. In this case, the operation sound abnormality determination means 6 determines that an operation sound is an abnormal sound when a distance between a vector representing the current operation sound and a vector representing the criterion operation sound is equal to or more than a threshold value, and determines that an operation sound is normal when the distance is less than the threshold value.

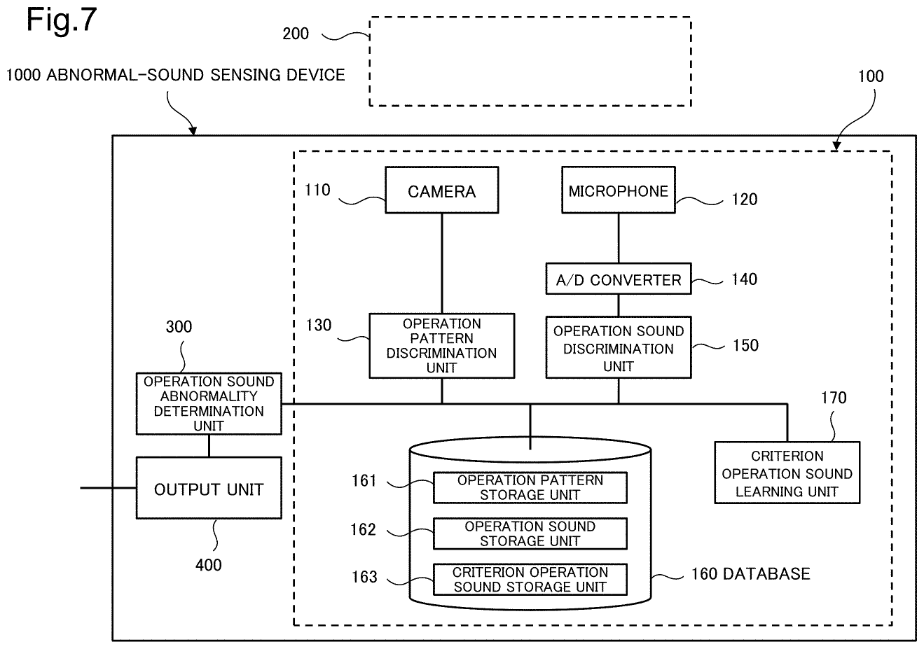

FIG. 7 is a block diagram illustrating a specific configuration example of the abnormal-sound sensing device. An abnormal-sound sensing device 1000 includes an abnormal-sound determination criterion generation device 100 similar to that according to the second example embodiment, and an operation sound abnormality determination unit 300. The abnormal-sound sensing device 1000 may include an output unit 400.

The operation sound abnormality determination unit 300 monitors an operation pattern discriminated by an operation pattern discrimination unit. The operation sound abnormality determination unit 300 determines whether a current operation pattern being monitored corresponds to an existing operation pattern stored in an operation pattern storage unit 161. Herein, when determining that the patterns correspond to each other, the operation sound abnormality determination unit 300 refers to a criterion operation sound relevant to the existing operation sound. Next, the operation sound abnormality determination unit 300 compares the criterion operation sound with a current operation sound discriminated by an operation sound discrimination unit 150. When a difference between the sounds is equal to or more than a predetermined value, the operation sound abnormality determination unit 300 determines that the current operation sound is abnormal. On the other hand, when a difference is less than the predetermined value, the operation sound abnormality determination unit 300 determines that the current operation sound is normal. As already described, a difference between the current operation sound and the criterion operation sound can be calculated as a distance in a vector space of a feature vector representing each sound, for example.

The output unit 400 outputs a determination result of the operation sound abnormality determination unit 300 to a display device or an output device such as a speaker.

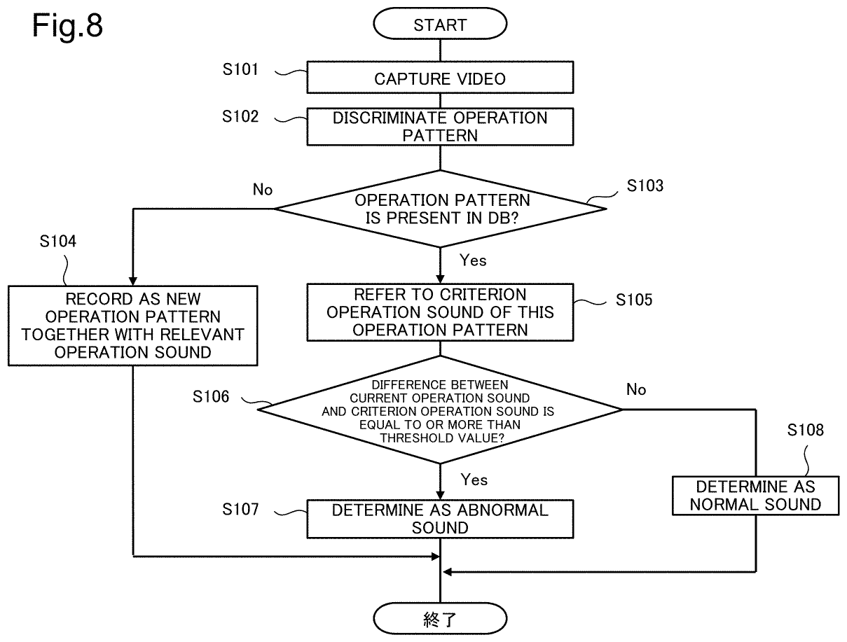

Next, an operation of the abnormal-sound sensing device 1000 is described. FIG. 8 is a flowchart illustrating this operation. First, a camera 110 captures a video of the diagnosis object 200 (S101). Next, an operation pattern discrimination unit 130 discriminates an operation pattern in the captured video (S102). The operation sound abnormality determination unit 300 determines whether the discriminated operation pattern is an operation pattern stored in a database (DB) (S103). Herein, when the discriminated operation pattern is an operation pattern that is not stored in the DB (S103_No), the operation sound abnormality determination unit 300 stores, in the DB, the operation pattern in combination with a relevant operation sound as a new operation pattern and operation sound (S104).

On the other hand, when the discriminated operation pattern is a known operation pattern stored in the DB (S103_Yes), the operation sound abnormality determination unit 300 refers to a relevant criterion operation sound (S105). The operation sound abnormality determination unit 300 compares the current operation sound with the criterion operation sound, and, when the difference between the operation sounds is equal to or more than a threshold value (S106_Yes), determines that the operation sound is an abnormal sound (S107). On the other hand, when the difference is less than the threshold value (S106_No), the operation sound abnormality determination unit 300 determines that the operation sound is a normal sound (S108). When determining that the operation sound is a normal sound, the operation sound abnormality determination unit 300 may update the criterion operation sound by adding the operation sound to data of machine learning.

As described above, according to the present example embodiment, since an abnormal sound is sensed by use of an abnormal-sound determination criterion generated based on an actually measured operation pattern and an operation sound, an unknown abnormal sound can also be sensed. Since an abnormal-sound determination criterion is set for each operation pattern, abnormal-sound sensing having high detection precision in which incorrect sensing is rare becomes possible.

### Fourth Example Embodiment

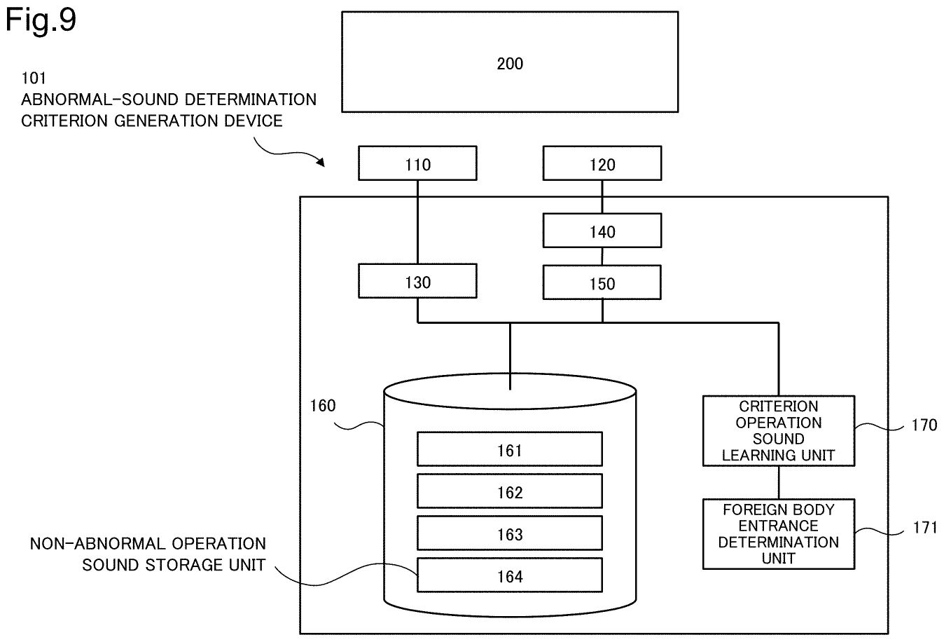

FIG. 9 is a block diagram illustrating an abnormal-sound determination criterion generation device 101 according to the present example embodiment. In the abnormal-sound determination criterion generation device 101, a criterion operation sound learning unit 170 includes a foreign body entrance determination unit 171, in addition to the configuration according to the second example embodiment.

The foreign body entrance determination unit 171 determines whether entrance of a foreign body is included in a video discriminated by an operation pattern discrimination unit 130, i.e., a video being monitored. Specifically, when a new feature point is generated in the video, the foreign body entrance determination unit 171 determines that “entrance of foreign body is present” by detecting the feature point. In other cases, the foreign body entrance determination unit 171 determines that “entrance of foreign body is absent”, and then outputs the result to the criterion operation sound learning unit 170.

When receiving an input “entrance of foreign body is present”, the criterion operation sound learning unit 170 interrupts learning of a criterion operation sound. The criterion operation sound learning unit 170 records a pattern of a sound measured at this time in a non-abnormal operation sound storage unit 164, as a “non-abnormal operation sound” resulting from a cause of entrance of a foreign body into an environment of abnormal-sound sensing, in association with the operation pattern.

On the other hand, when receiving an input “entrance of foreign body is absent”, the criterion operation sound learning unit 170 continues learning of a combination of an operation pattern and an operation sound.

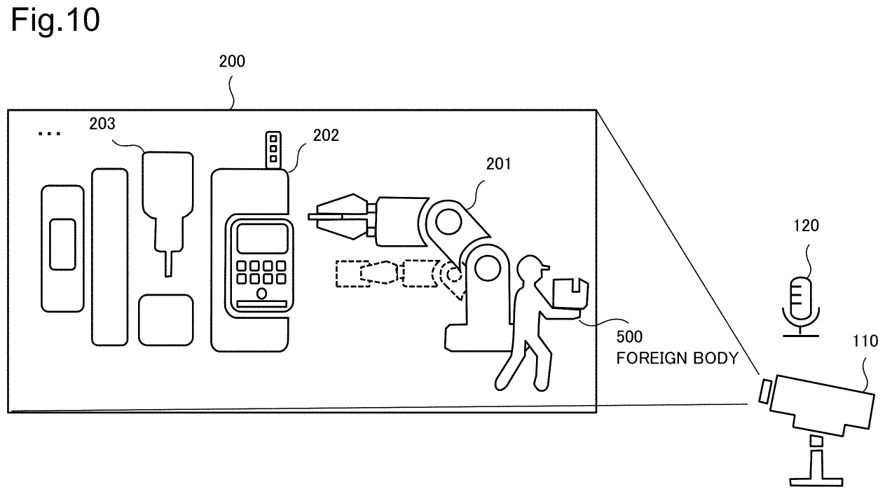

FIG. 10 is a schematic diagram illustrating status of “entrance of foreign body is present”. A facility in a factory similar to that in FIG. 3 is assumed as a diagnosis object 200. A video exemplified in FIG. 10 contains a foreign body 500 in addition to facilities 201, 202, 203, . . . . The foreign body 500 is, for example, a person moving with luggage.

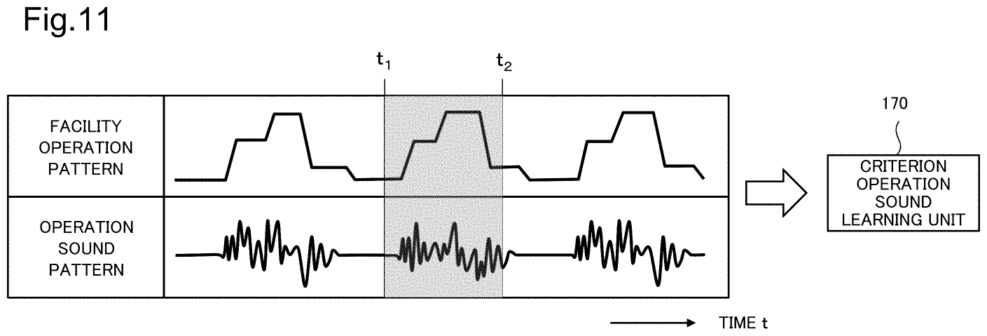

A sound generated by such a foreign body, for example, a foreign body such as entrance of a person into a monitoring area or carrying of goods is a sound being desired to be differentiated from an abnormal sound inherent in a facility. Thus, in the present example embodiment, when a foreign body is detected, machine learning of a criterion operation sound relevant to an operation sound is interrupted. Specifically, a feature point of a foreign body that has never existed is detected in a video discriminated by the operation discrimination unit 130, and the foreign body entrance determination unit 171 determines that “entrance of foreign body is present”. While the foreign body 500 is detected, the criterion operation sound learning unit 170 interrupts learning of an operation sound. With regard to machine learning in the example of FIG. 10, association of a facility operation pattern and an operation sound pattern is schematically illustrated in FIG. 11. FIG. 11 illustrates that a foreign body is detected between times t₁ and t₂, during which learning of the facility operation pattern and the operation sound pattern is interrupted.

As described above, according to the present example embodiment, a criterion operation sound can be learned by excluding a sound generated independently of a diagnosis object. Thus, an abnormal-sound determination criterion with which it is possible to automatically discriminate whether an abnormal sound is an abnormal sound attributed to a diagnosis object or an obvious abnormal sound attributed to an environmental change can be set.

### Fifth Example Embodiment

An abnormal-sound sensing device can be configured by use of the abnormal-sound determination criterion generation device according to the fourth example embodiment. This abnormal-sound sensing device is different from that according to the third example embodiment in that machine learning of a criterion operation sound is interrupted when entrance of a foreign body is present. In the example described below, sensing of an abnormal sound is also interrupted when entrance of a foreign body is present.

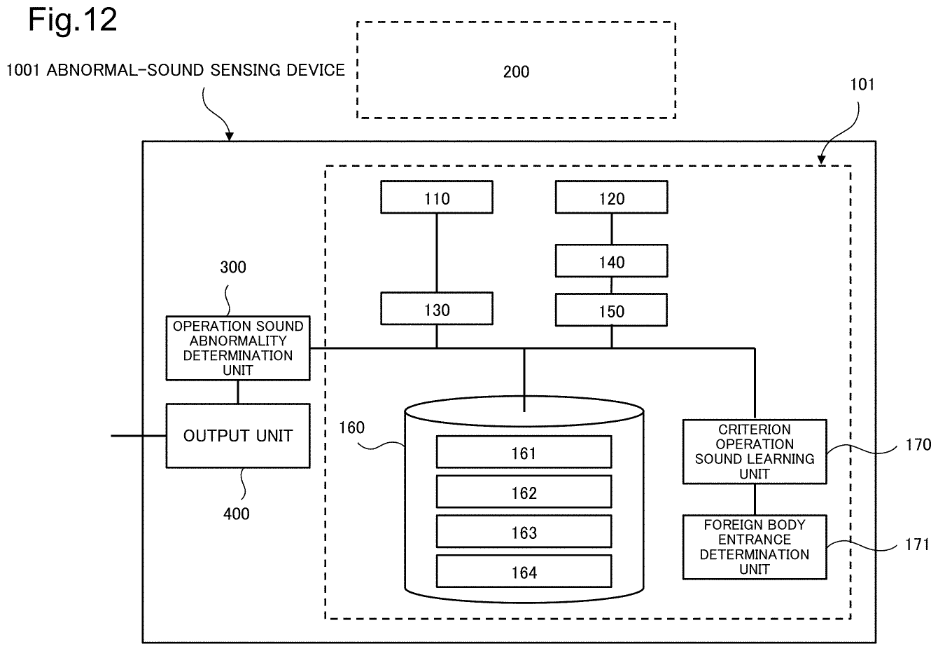

FIG. 12 is a block diagram illustrating an abnormal-sound sensing device 1001 according to the present example embodiment. The abnormal-sound sensing device 1001 includes the abnormal-sound determination criterion generation device 101 according to the fourth example embodiment, an operation sound abnormality determination unit 300, and an output unit 400.

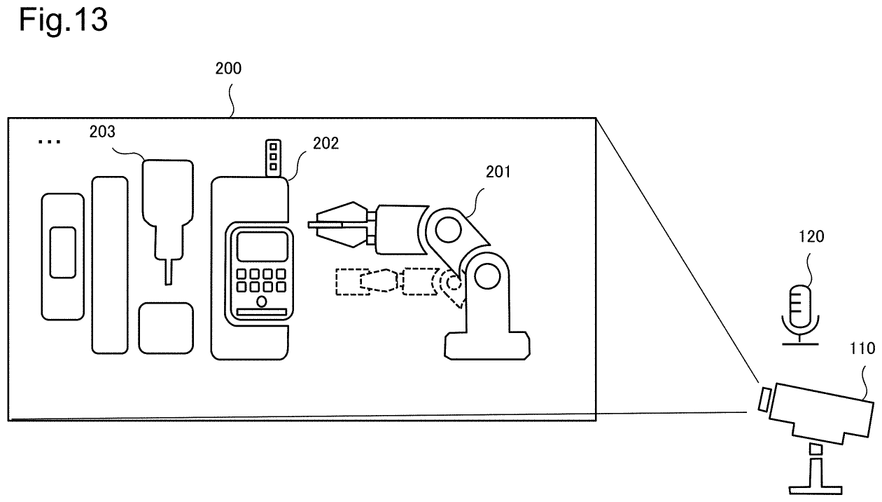

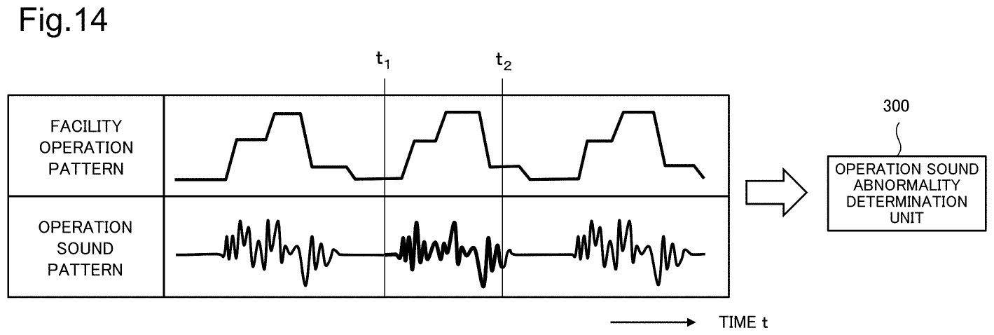

When entrance of a foreign body is present as in FIG. 10, the abnormal-sound sensing device 1001 interrupts abnormal sound sensing. The abnormal-sound sensing device 1001 records a pattern of a sound measured at this time in a database 160, as a “non-abnormal operation sound” resulting from a cause of entrance of a foreign body into a diagnosis object, in combination with an operation pattern of the foreign body. On the other hand, when entrance of a foreign body is absent, the abnormal-sound sensing device 1001 continues abnormal sound sensing. A drawing in which a situation of this abnormal sound sensing is schematically depicted is illustrated in FIG. 13. In FIG. 13, no foreign body is detected in a video of the diagnosis object 200. In such a case, when an acquired operation sound is a predetermined value or more different from a criterion operation sound, an abnormal sound is sensed. This sensing operation is schematically illustrated in FIG. 14. In the example of FIG. 14, while a facility operation pattern periodically repeats the same pattern, an operation sound pattern different from other patterns is generated between the times t₁ and t₂. In such a case, the abnormal-sound sensing device 1001 senses an abnormal sound. An alarm can be set up by outputting an abnormal-sound sensing result from the output unit.

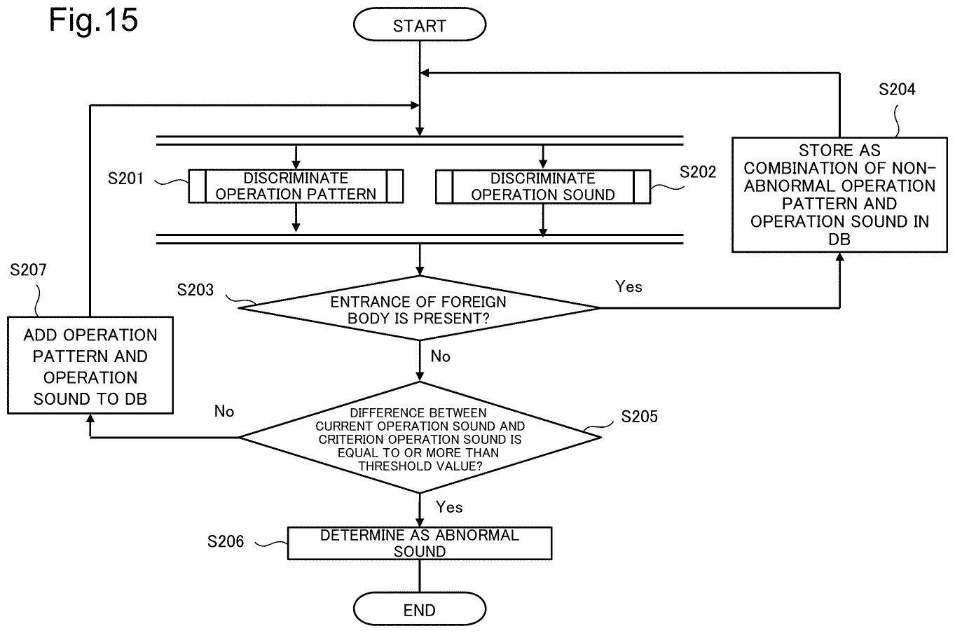

FIG. 15 is a flowchart illustrating an abnormal-sound sensing operation of the abnormal-sound sensing device 1001. First, the abnormal-sound sensing device 1001 discriminates an operation pattern (S201). As described in the third example embodiment, S201 is processing including capture of a video and discrimination of an operation pattern in the video. In parallel therewith, the abnormal-sound sensing device 1001 discriminates an operation sound (S202). As already described, discrimination of an operation sound is processing including sound collection, A/D conversion, and discrimination of a sound pattern. Herein, the abnormal-sound sensing device 1001 determines whether entrance of a foreign body is present (S203), and interrupts an abnormality determination operation when entrance of a foreign body is present (S203_Yes). The abnormal-sound sensing device 1001 records an operation sound relevant to an operation pattern of the foreign body entrance in a DB as a “non-abnormal operation sound” (S204). On the other hand, when entrance of a foreign body is absent (S203_No), the abnormal-sound sensing device 1001 continues abnormal determination. When a difference between the current operation sound and the criterion operation sound is equal to or more than a threshold value, the abnormal-sound sensing device 1001 determines that the operation sound is an abnormal sound (S206). On the other hand, when the difference between the current operation sound and the criterion operation sound is less than the threshold value (S205_No), the abnormal-sound sensing device 1001 stores the operation pattern and the operation sound in an operation pattern storage unit 161 and an operation sound storage unit 162, respectively (S207). The operation sound stored herein is an operation sound during a normal time, and therefore, contributes to learning of a criterion operation sound. After storing data, the abnormal-sound sensing device 1001 returns to S201 and S202, and continues diagnosis of an abnormal sound.

By the operation described above, an operation sound resulting from entrance of a foreign body during an irregular state can be excluded from a diagnosis object. In other words, an unrelated sound generated by an object other than a diagnosis object can be excluded, and precision of an abnormal-sound diagnosis can be improved. As a result, incorrect detection of an abnormal sound generated from a diagnosis object can be suppressed, and an improvement in detection precision can be made.

A program causing a computer to execute the processing according to the first to fifth example embodiments described above, and a recording medium storing the program also fall within the scope of the present invention. For example, a magnetic disk, a magnetic tape, an optical disk, a magnet-optical disk, a semiconductor memory, or the like can be used as a recording medium.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2018-026169, filed on Feb. 16, 2018, the disclosure of which is incorporated herein in its entirety by reference.

### REFERENCE SIGNS LIST

1 Imaging means
2 Operation pattern discrimination means
3 Sound collection means
4 Operation sound discrimination means
5 Criterion operation sound learning means
6 Operation sound abnormality determination means
100, 101 Abnormal-sound determination criterion generation device
110 Camera
120 Microphone
130 Operation pattern discrimination unit
140 A/D converter
150 Operation sound discrimination unit
160 Database
161 Operation pattern storage unit
162 Operation sound storage unit
163 Criterion operation sound storage unit
164 Non-abnormal operation sound storage unit
170 Criterion operation sound learning unit
171 Foreign body entrance determination unit
200 Diagnosis object
300 Operation sound abnormality determination unit
400 Output unit
500 Foreign body
1000, 1001 Abnormal-sound sensing device

1. An abnormal-sound determination criterion generation device comprising:
at least one memory storing instructions; and
at least one processor configured to access the at least one memory and execute the instructions to:
discriminate an operation pattern of a diagnosis object, based on a video of the diagnosis object captured by a camera;
discriminate, as an operation sound relevant to the operation pattern, a pattern of a sound arriving from the diagnosis object, the sound collected in synchronization with the discriminated operation pattern by a microphone; and
generate a criterion operation sound to be a criterion of the operation sound in the operation pattern by machine-learning based on the operation sound relevant to the operation pattern.

2. The abnormal-sound determination criterion generation device according to claim 1, wherein,
the at least one processor is further configured to execute the instructions to:
when the diagnosis object repeatedly performs an operation,
learn the operation sound by a predetermined number of times of the repeated operation.

3. The abnormal-sound determination criterion generation device according to claim 1, wherein,
the at least one processor is further configured to execute the instructions to:
when entrance of a foreign body is present in the video,
interrupt learning of the operation sound.

4. The abnormal-sound determination criterion generation device according to claim 1, wherein
the criterion operation sound
is noted with a multi-dimensional vector in which at least either a relative time from a criterion time or a frequency of a sound waveform is a dimension.

5. An abnormal-sound sensing device comprising:
the abnormal-sound determination criterion generation device according to claim 1,
wherein
the at least one processor is further configured to execute the instructions to:
determine whether the operation sound is abnormal by comparing the criterion operation sound generated by the abnormal-sound determination criterion generation device with the operation sound of the diagnosis object.

6. The abnormal-sound sensing device according to claim 5, wherein, when entrance of a foreign body is present in the video,
determination of an abnormality of the operation sound is interrupted.

7. The abnormal-sound sensing device according to claim 5, wherein
the criterion operation sound and the operation sound
are noted with a multi-dimensional vector in which at least either a relative time from a criterion time or a frequency of a sound waveform is a dimension, and
determination of an abnormality of the operation sound is performed based on a distance between a vector relevant to the criterion operation sound in a multi-dimensional space and a vector relevant to the operation sound.

8. An abnormal-sound determination criterion generation method comprising:
capturing a video of a diagnosis object;
discriminating an operation pattern of the diagnosis object, based on the video;
collecting a sound arriving from the diagnosis object;
discriminating, as an operation sound relevant to the operation pattern, a pattern of the sound collected in synchronization with the discriminated operation pattern; and
generating a criterion operation sound to be a criterion of the operation sound in the operation pattern by machine-learning based on the operation sound relevant to the operation pattern.

9. The abnormal-sound determination criterion generation method according to claim 8, further comprising:
determining whether the operation sound is abnormal by comparing the criterion operation sound with the operation sound of the diagnosis object.

10. A non-transitory computer-readable storage medium storing an abnormal-sound sensing program that causes a computer to execute:
a step of discriminating an operation pattern of a diagnosis object, based on the video a video of the diagnosis object captured by a camera;
a step of discriminating, as an operation sound relevant to the operation pattern, a pattern of a sound arriving from the diagnosis object, the sound collected in synchronization with the discriminated operation pattern by a microphone;
a step of learning a criterion operation sound to be a criterion of the operation sound in the operation pattern by machine-learning based on the operation sound relevant to the operation pattern; and
a step of determining whether the operation sound is abnormal by comparing the criterion operation sound with the operation sound of the diagnosis object.
